(19) United States
(12) Patent Application Publication
(10) Pub. No.: US 2026/0160700 A1
(43) Pub. Date: Jun. 11, 2026

(54) SURFACE TOPOGRAPHY INSPECTION SYSTEM

(71) Applicant: BENANO INC., Taipei City (TW)

(72) Inventor: Liang-Pin YU, Taipei City (TW)

(21) Appl. No.: 19/412,547

(22) Filed: Dec. 8, 2025

(30) Foreign Application Priority Data
Dec. 9, 2024 (TW) 113147699

(51) Int. Cl. G01N 21/88; G01B 11/25

(52) U.S. Cl. CPC G01N 21/8806; G01B 11/2513; G01B 11/2518

(57) ABSTRACT

A surface topography inspection system is adapted to inspect a surface of an object placed on a bearing surface parallel to a scanning direction. The system includes an optical pattern generator having an optical pattern generating surface, a sensor having a light-sensing surface, and a lens assembly. The optical pattern generating surface is angled with respect to the scanning direction, and emits a periodically patterned light beam toward the bearing surface. The lens assembly permits passage of the periodically patterned light beam, thereby forming a projected focal plane pattern that is oblique to the scanning direction. The lens assembly receives and redirects the projected focal plane pattern reflected by the object to the sensor, thereby forming the projected focal plane pattern on the light-sensing surface.

### CROSS-REFERENCE TO RELATED APPLICATION

This application claims priority to Taiwanese Invention Patent Application No. 113147699, filed on December 9, 2024, the entire disclosure of which is incorporated by reference herein.

### FIELD

The disclosure relates to a surface topography inspection system, and more particularly to a system that projects a periodic pattern onto a target object to detect variations in heights of a surface structure of the object.

### BACKGROUND

In advanced semiconductor packaging, the quality of wafer bumps (e.g., positions and heights of the bumps) is a critical factor in process control. Therefore, bump quality must be inspected, which involves examining the surface topography of the bumps. Conventional surface topography inspection systems typically rely on optical measurement techniques. However, as bump dimensions continue to shrink, extremely high optical resolution is required for inspection, thereby resulting in a very shallow depth of field. Consequently, given that wafer warpage is unavoidable, accurately focusing on the bumps for inspection becomes increasingly challenging.

In semiconductor packaging process lines, full-wafer inspection is typically performed using surface topography inspection systems, such as reflective triangulation or structured illumination microscopy (SIM). In reflective triangulation, the incident direction of the light source must form an angle with the light collection direction of the sensor. As a result, the light can only be incident from the side, leading to a shadow effect. On the other hand, referring to FIG. 1A, conventional structured illumination microscopy projects a focal plane pattern P′ (e.g., a sine pattern) onto an object surface 200 using a projector. The projected focal plane pattern P′ is parallel to a horizontal direction and perpendicular to a height (vertical) direction. A camera then captures images of the projected focal plane pattern P’ on the object surface 200. In FIG. 1A, a horizontal range of the projected pattern P′ is exemplified by horizontal positions X1 to X15, and a field of view (FOV) 201 of the camera covers ranges such as horizontal positions X1 to X8, X9 to X15, and so on. The SIM system operates by remaining stationary in the horizontal direction while scanning along the height direction, thereby forming multiple projected focal plane patterns P′1 to P′8 that correspond to vertical positions Y1 to Y8, respectively. After the camera captures images of the projected focal plane patterns P′1 to P′8, focus measures are performed based on characteristics of the projected focal plane pattern P′, such as sinusoidal amplitude, light intensity, and/or gradient, but this disclosure is not limited in this respect. For example, as shown in FIG. 1B, a depth of focus curve at a horizontal position X2 may be derived, and the peak of this curve indicates that the height of the object surface 200 at the horizontal position X2 corresponds to a vertical position Y4. Similarly, depth of focus curves can be obtained for positions X1 through X8, yielding height information across the object surface 200. Since the length of the object surface 200 in the horizontal direction exceeds the field of view 201 of the camera, after obtaining height information for one FOV, the system has to shift horizontally to the next FOV and repeat the vertical scanning process, so as to completely scan the object surface 200. Therefore, conventional structured illumination microscopy requires repeated stop-and-go operations in both the horizontal and vertical directions, resulting in long inspection times. Although sampling-based inspection is possible, it does not meet the throughput requirements for in-line production inspection.

### SUMMARY

Therefore, an object of the disclosure is to provide a surface topography inspection system that can alleviate at least one of the drawbacks of the prior art.

According to the disclosure, the surface topography inspection system is adapted to inspect a surface of an object that is placed on a bearing surface. The bearing surface is parallel to a scanning direction in which the surface of the object is to be scanned. The surface topography inspection system includes an optical pattern generator, a sensor, and a lens assembly. The optical pattern generator includes an optical pattern generating surface that is angled with respect to the scanning direction, and is configured to emit a periodically patterned light beam with periodic brightness variations toward the bearing surface. The sensor includes a light-sensing surface. The lens assembly is disposed to receive the periodically patterned light beam, and is configured to permit passage of the periodically patterned light beam, thereby projecting the periodically patterned light beam perpendicularly toward the bearing surface to form a projected focal plane pattern that is oblique to the scanning direction. The lens assembly is disposed to receive the projected focal plane pattern reflected by the object, and is configured to redirect the projected focal plane pattern thus received to the sensor, thereby forming the projected focal plane pattern on the light-sensing surface.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1A is a schematic diagram illustrating a conventional structured illumination microscopy technique, in which scanning is performed in a height direction, and multiple projected focal plane patterns are sequentially projected relative to a surface of an object.

FIG. 1B is a plot illustrating a depth of focus curve corresponding to a horizontal position X2 shown in FIG. 1A.

FIG. 2 is a schematic diagram illustrating an embodiment of a surface topography inspection system according to this disclosure, applied to inspect a surface of a to-be-inspected object.

FIG. 3 is a block diagram illustrating connection relationships between the embodiment and a driver.

FIG. 4 is a schematic diagram illustrating a variation of a lens assembly according to the embodiment.

FIG. 5 is a schematic diagram illustrating another variation of the lens assembly.

FIG. 6A is a schematic diagram illustrating the embodiment scanning along a first scanning direction and projecting multiple projected focal plane patterns relative to the surface of the to-be-inspected object.

FIG. 6B is a plot illustrating a depth of focus curve corresponding to a horizontal position X2 shown in FIG. 6A.

FIGS. 7A to 7E are schematic diagrams illustrating different types of patterns formed on a projected focal plane by a periodic patterned light beam emitted by a light pattern generator of the embodiment.

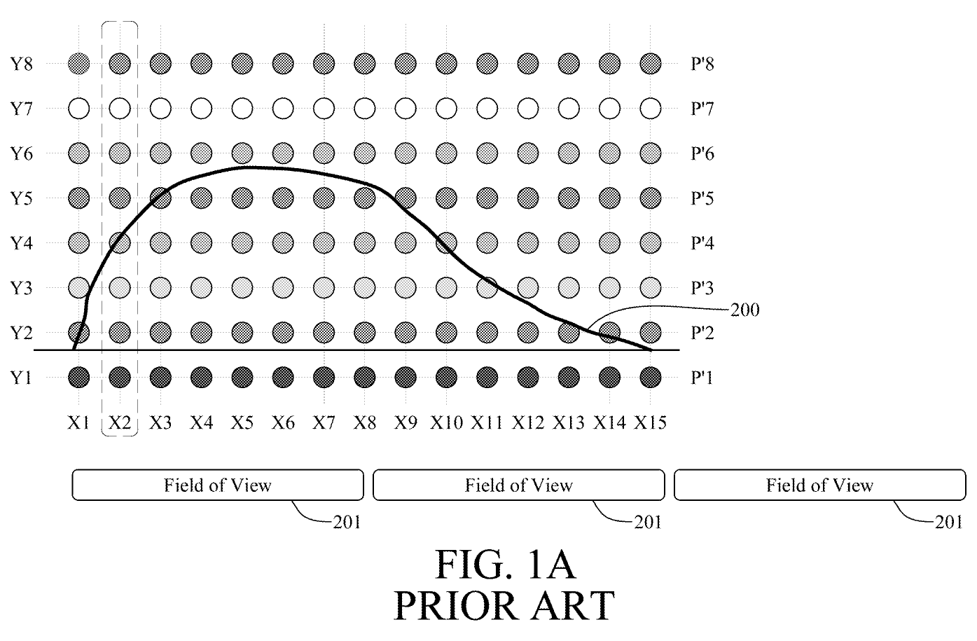

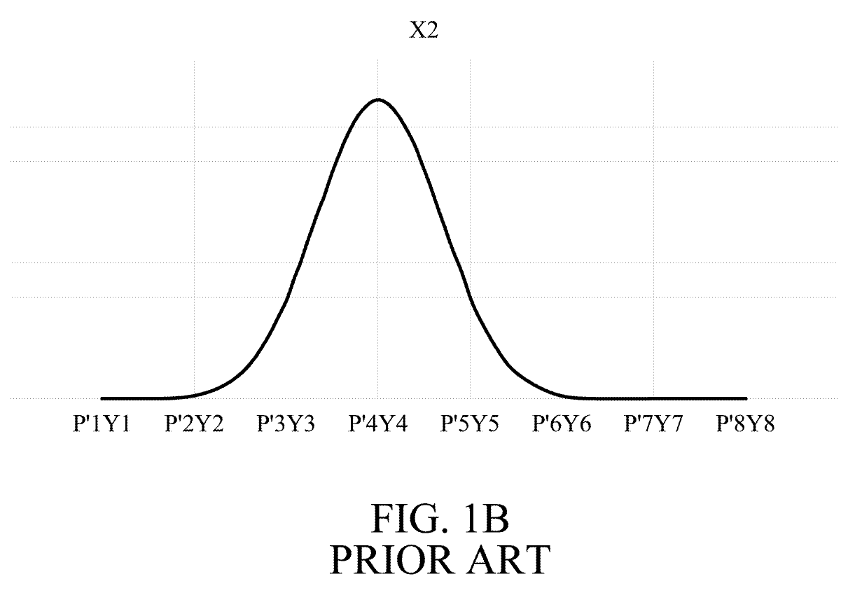

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

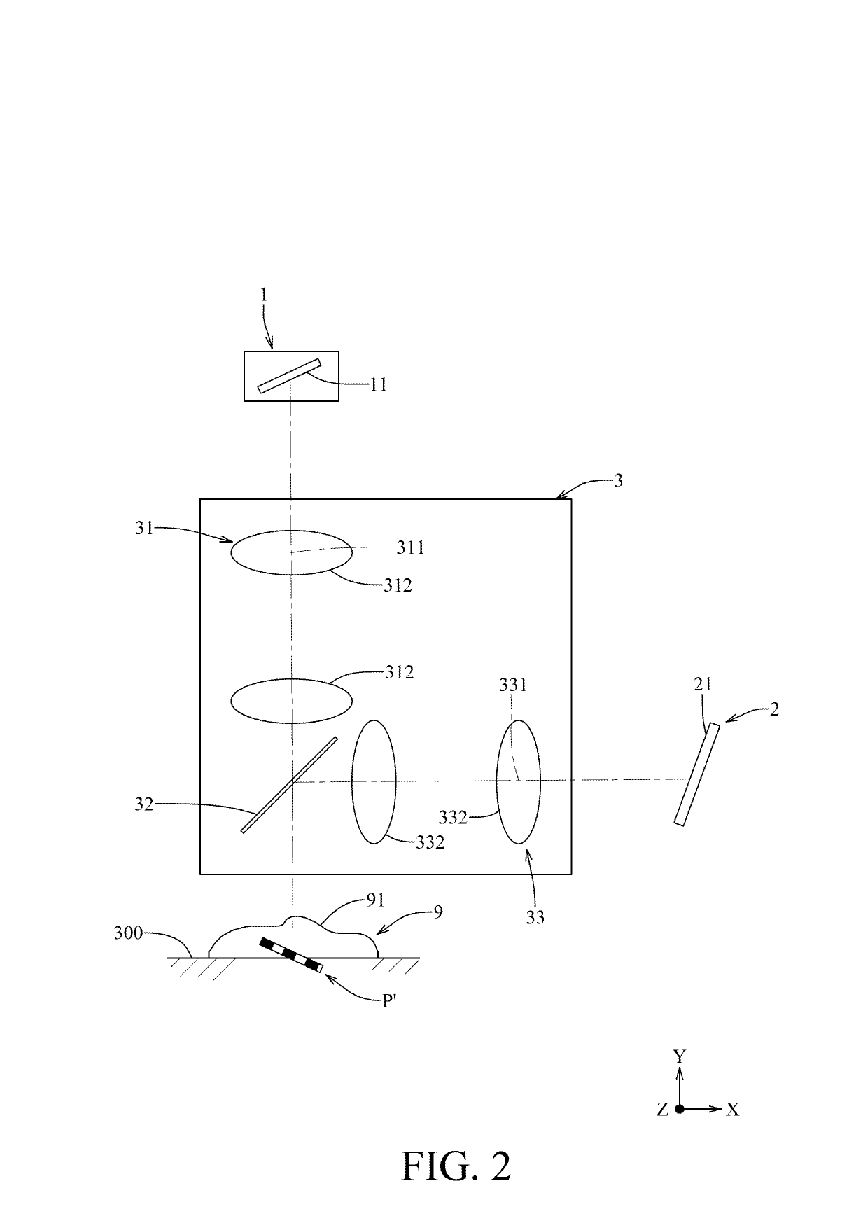

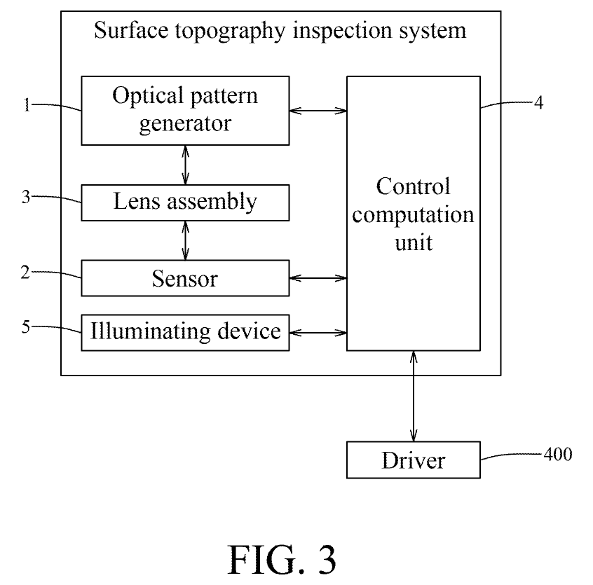

Referring to FIGS. 2 and 3, an embodiment of a surface topography inspection system according to this disclosure is adapted to measure a surface 91 of a to-be-inspected object 9 that faces upward, thereby inspecting a three-dimensional (3D) topology of the surface 91. The object 9 may be, for example, a wafer provided with bumps, but this disclosure is not limited in this respect. The object 9 is placed on a bearing surface 300 that is parallel to a first scanning direction X and a second scanning direction Z, where the second scanning direction Z is transverse or perpendicular to the first scanning direction X. The bearing surface 300 may be, for example, a top surface of a stage (not shown), and may be driven by a driver 400, which may include, for example, a motor, to move along the first scanning direction X and/or the second scanning direction Z, such that the object 9 (or the bearing surface 300) and the surface topography inspection system move relative to each other along the first scanning direction X and/or the second scanning direction Z. In some embodiments, the bearing surface 300 may be fixed and immovable, and the driver 400 is installed on the surface topography inspection system and is able to drive movement of the surface topography inspection system, thereby causing the object 9 (or the bearing surface 300) and the surface topography inspection system to move relative to each other.

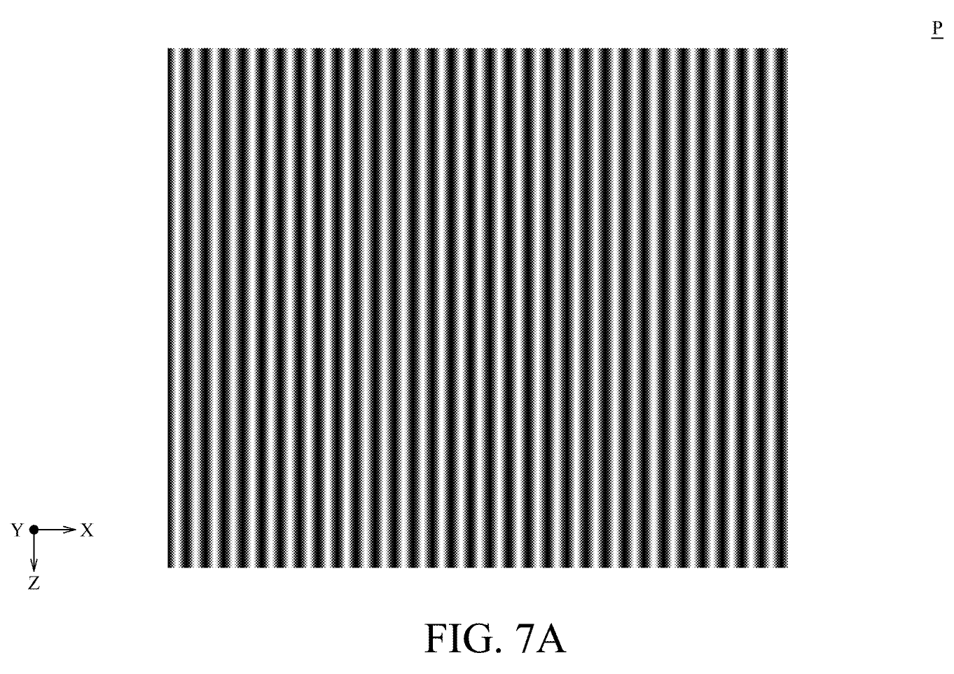

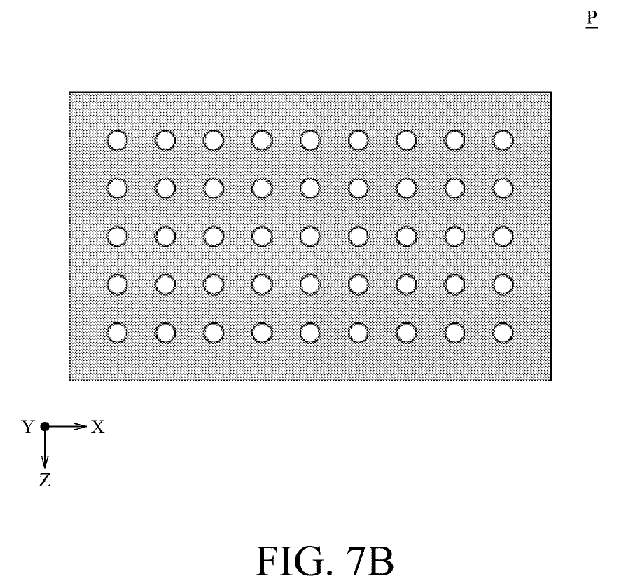

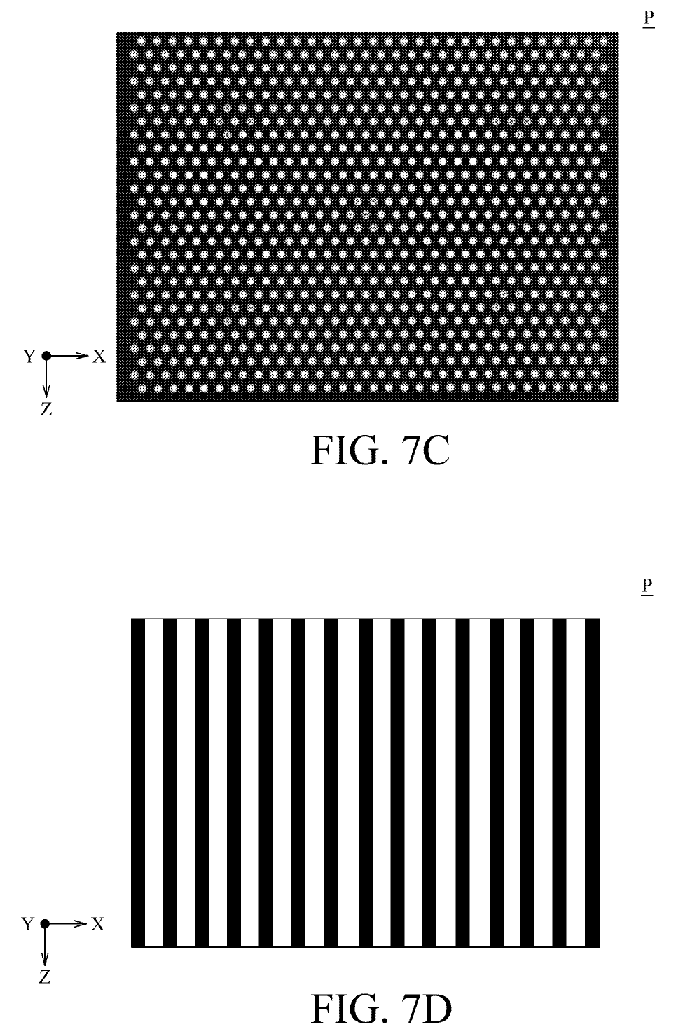

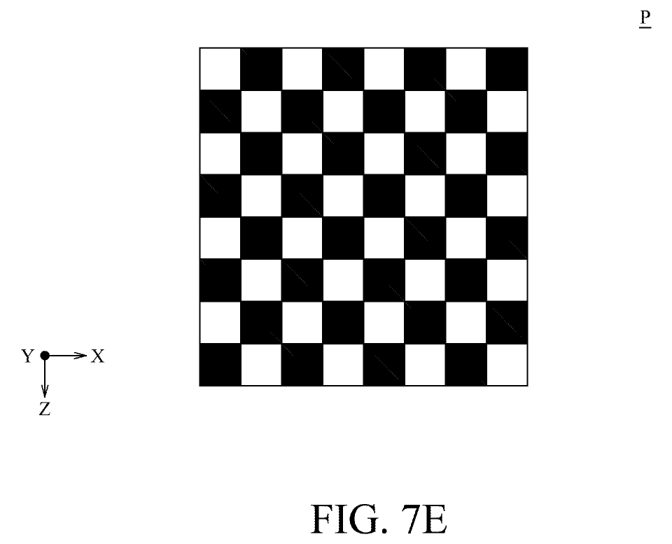

Referring to FIGS. 2 and 7A, the surface topography inspection system is adapted to measure a height variation of the surface 91 of the object 9 in a height direction Y, which is perpendicular to the first scanning direction X and the second scanning direction Z. The surface topography inspection system includes an optical pattern generator 1, a sensor 2, a lens assembly 3, and a control computation unit 4 that is electrically connected to the optical pattern generator 1, the sensor 2, and the driver 400. The optical pattern generator 1 includes an optical pattern generating surface 11 that is angled with respect to the first scanning direction X (i.e., oblique or not parallel to the first scanning direction X). The optical pattern generating surface 11 is operable to emit a periodically patterned light beam P that has periodic intensity or brightness variations for forming a projected focal plane pattern P’ on a projected focal plane of the lens assembly 3. In this embodiment, the projected focal plane pattern P’ varies periodically along the first scanning direction X. In one embodiment, the optical pattern generator 1 may be a micro display (e.g., a display screen) electrically connected to the control computation unit 4, so the micro display is operable by the control computation unit 4 to output the periodically patterned light beam P of different patterns based on a setting received by the control computation unit 4. In one embodiment, the optical pattern generator 1 may be equipped with a light source and a grating. The grating has the optical pattern generating surface 11 and permits passage of light to emit the periodically patterned light beam P. In accordance with some embodiments, the grating may be a photomask or film fabricated by development, etching, or printing processes. Light emitted from the light source passes through the grating to produce a beam corresponding to a pattern of the grating. In this way, users can replace the grating with one having a different pattern according to actual requirements, thereby allowing the pattern projected by the periodically patterned light beam P to vary based on demand.

In accordance with some embodiments, the periodically patterned light beam P that has been projected on a plane may form, for example, a sine pattern as illustrated in FIG. 7A, a circular aperture pattern arranged in an array as illustrated in FIG. 7B, an aperture pattern arranged in a honeycomb configuration as illustrated in FIG. 7C, a stripe pattern as illustrated in FIG. 7D, and a chessboard pattern as illustrated in FIG. 7E. In the illustrative embodiment, the periodically patterned light beam P is exemplified to form the sine pattern resembling light and dark fringes when projected onto a plane.

Referring to FIG. 2, the sensor 2 is configurable to set a tilt angle, and includes a light-sensing surface 21. In accordance with some embodiments, the sensor 2 may be a camera, and the light-sensing surface 21 may be a photosensitive chip (e.g., an image sensor chip) of the camera, but this disclosure is not limited in this respect. The tilt angle of the sensor 2 is set in such a way that the light-sensing surface 21 forms an imaging focal plane through the lens assembly 3, where the imaging focal plane is coplanar and coincident with the projected focal plane formed by the optical pattern generating surface 11 through the lens assembly 3, such that the light-sensing surface 21 and the optical pattern generating surface 11 lie on optically conjugate planes relative to the lens assembly 3. Therefore, the sensor 2 and the optical pattern generator 1 can be interchangeably positioned along the first scanning direction X and the height direction Y, and one of the sensor 2 and the optical pattern generator 1 is aligned with and faces toward the object 9.

Referring to FIG. 2, the lens assembly 3 is disposed on a first optical path along which the periodically patterned light beam P propagates from the optical pattern generator 1 to the bearing surface 300 or the object 9, and on a second optical path along which the projected focal plane pattern P’ is transmitted to the sensor 2. The lens assembly 3 has a first optical axis 311 aligned with the optical pattern generating surface 11 to receive the periodically patterned light beam P, and is configured to permit passage of the periodically patterned light beam P, thereby projecting the periodically patterned light beam P toward the bearing surface 300. The lens assembly 3 is disposed to receive the projected focal plane pattern P’ reflected by the object 9, and further has a second optical axis 331 aligned with the light-sensing surface 21 to redirect the projected focal plane pattern P’ thus received to the sensor 2. In detail, the lens assembly 3 includes a first lens unit 31, a beam splitter 32, and a second lens unit 33. The first lens unit 31 includes a plurality of first lens elements 312 that have optically aligned optical centers, thereby defining the first optical axis 311 that intersects the optical pattern generating surface 11. The first optical axis 311 may be parallel to the first scanning direction X or the height direction Y. In this embodiment, the first optical axis 311 is perpendicular to the first scanning direction X and parallel to the height direction Y, and is oblique to the optical pattern generating surface 11. As a result, the periodically patterned light beam P emitted from the optical pattern generating surface 11 passes through the first lens unit 31 along the first optical axis 311, and is projected perpendicularly toward the bearing surface 300 by the first lens unit 31 to form the projected focal plane pattern P’ on the projected focal plane of the first lens unit 31, where the projected focal plane pattern P’ is oblique to the first scanning direction X. In accordance with some embodiments, the first lens unit 31 is an object-side telecentric lens with a long focal length (e.g., equal to or greater than ten times a height variation range of the surface 91 of the object 9), or a bi-telecentric lens, and optionally has a large aperture.

The beam splitter 32 is configured to allow light to propagate in two different directions, and is disposed on an extension of the first optical axis 311 at a position to permit passage of the periodically patterned light beam P emitted from the optical pattern generating surface 11, and to reflect the projected focal plane pattern P’ from the object 9 to the light-sensing surface 21. In this embodiment, the object 9, the beam splitter 32 and the optical pattern generator 1 are arranged in the given order along the height direction Y, and the sensor 2 is offset from the optical pattern generator 1 along the height direction Y. Light emitted from the optical pattern generating surface 11 passes through the beam splitter 32 and illuminates the surface 91 of the object 9. The projected focal plane pattern P’ projected onto the surface 91 of the object 9 is first reflected back to the beam splitter 32, then reflected by the beam splitter 32 to form an image on the light-sensing surface 21. In some embodiments (not shown), the object 9, the beam splitter 32 and the sensor 2 may be arranged in the given order along the height direction Y, and the optical pattern generator 1 is offset from the sensor 2 along the height direction Y. As a result, the first optical axis 311 is parallel to the first scanning direction X, and light emitted from the optical pattern generating surface 11 propagates to the beam splitter 32 along the first scanning direction X, and then is reflected by the beam splitter 32 toward the bearing surface 300 and thus projected onto the surface 91 of the object 9. The resultant projected focal plane pattern P’ is reflected back to the beam splitter 32, and then passes through the beam splitter 32 to form an image on the light-sensing surface 21. In other words, the positions of the optical pattern generator 1 and the sensor 2 are interchangeable, depending on actual requirements.

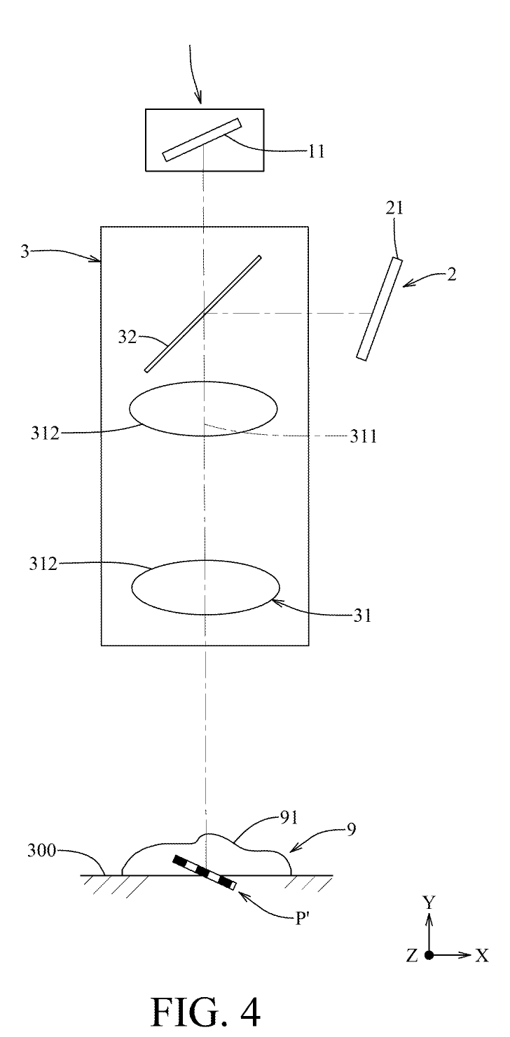

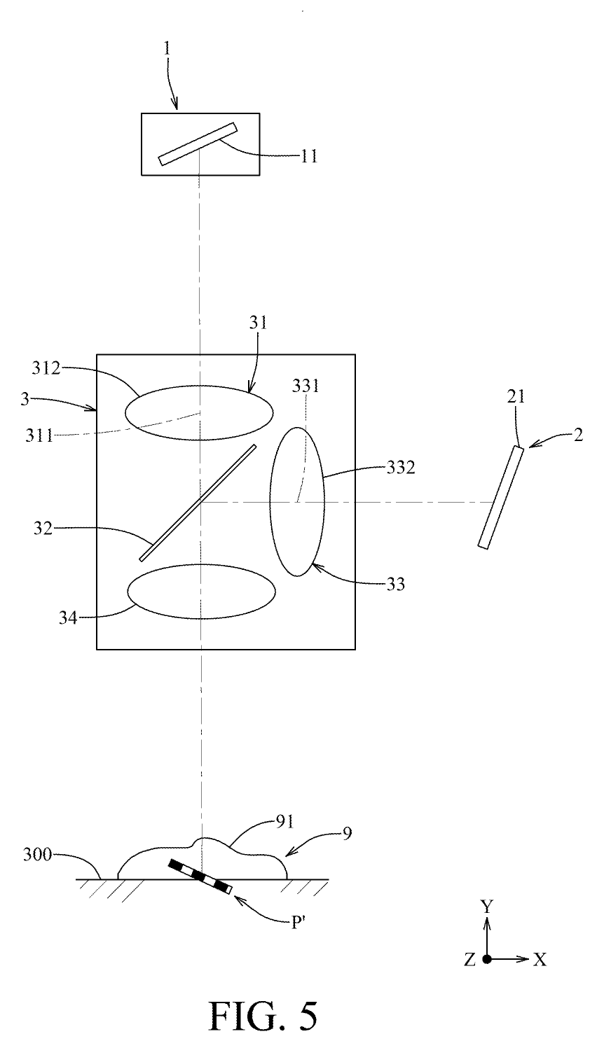

In some embodiments, the beam splitter 32 may be disposed between the first lens unit 31 and the object 9, as illustrated in FIG. 2. In some embodiments, the beam splitter 32 may be disposed between the first lens unit 31 and the optical pattern generator 1, as illustrated in FIG. 4. In some embodiments, the beam splitter 32 may be disposed between two of the first lens elements 312 of the first lens unit 31, as illustrated in FIG. 5. This disclosure is not limited in this respect.

The second lens unit 33 is disposed between the beam splitter 32 and the sensor 2, and is configured to image the projected focal plane pattern P’ onto the light-sensing surface 21. In accordance with some embodiments, the second lens unit 33 may be implemented using, for example, an object-side telecentric lens with a long focal length, or a bi-telecentric lens, and optionally has a large aperture to promote imaging efficiency and accuracy, but this disclosure is not limited in this respect. The second lens unit 33 defines the second optical axis 331 that intersects the beam splitter 32 and a center of the light-sensing surface 21 and that is transverse or perpendicular to the first optical axis 311, and includes a plurality of second lens elements 332. In accordance with some embodiments, an optical magnification of the second lens unit 33 may be different from an optical magnification of the first lens unit 31. In the present embodiment, both the second lens unit 33 and the first lens unit 31 are exemplified as lens assemblies each including two lens elements. FIG. 4 illustrates a variation of the embodiment, where the first lens unit 31 is configured to perform the functions of both the first lens unit 31 and the second lens unit 33 in FIG. 2. In this variation, the first lens unit 31 is disposed between the object 9 and the beam splitter 32 along the height direction Y, so the projected focal plane pattern P’ reflected by the object 9 passes through the first lens unit 31, and then is reflected by the beam splitter 32 to the light-sensing surface 21. FIG. 5 illustrates another variation of the embodiment, where the second lens unit 33 shares one or more lens elements with the first lens unit 31. In the illustrative variation, the lens assembly 3 includes a first lens element 312, a beam splitter 32, a second lens element 332, and a shared lens element 34. The periodically patterned light beam P emitted from the optical pattern generating surface 11 passes through the first lens unit 31 constituted by the first lens element 312 and the shared lens element 34 to form the projected focal plane pattern P’, and the projected focal plane pattern P’ reflected by the object 9 is redirected by the beam splitter 32 toward the sensor 2 and passes through the second lens unit 33 constituted by the second lens element 332 and the shared lens element 34 to image the projected focal plane pattern P’ onto the light-sensing surface 21.

Referring to FIGS. 2, 3 and 6A, the control computation unit 4 is configured to control the driver 400 to enable the optical pattern generator 1 and the bearing surface 300 (along with the object 9 placed thereon) to move relative to each other along the first scanning direction X. In accordance with some embodiments, the control computation unit 4 may be implemented using a computer, but this disclosure is not limited in this respect. The control computation unit 4 controls the optical pattern generator 1 to continuously emit the periodically patterned light beam P during the relative movement of the optical pattern generator 1 and the bearing surface 300 along the first scanning direction X, and controls the sensor 2 to, via the lens assembly 3, continuously form the projected focal plane pattern P’ on the light-sensing surface 2 based on the periodically patterned light beam P.

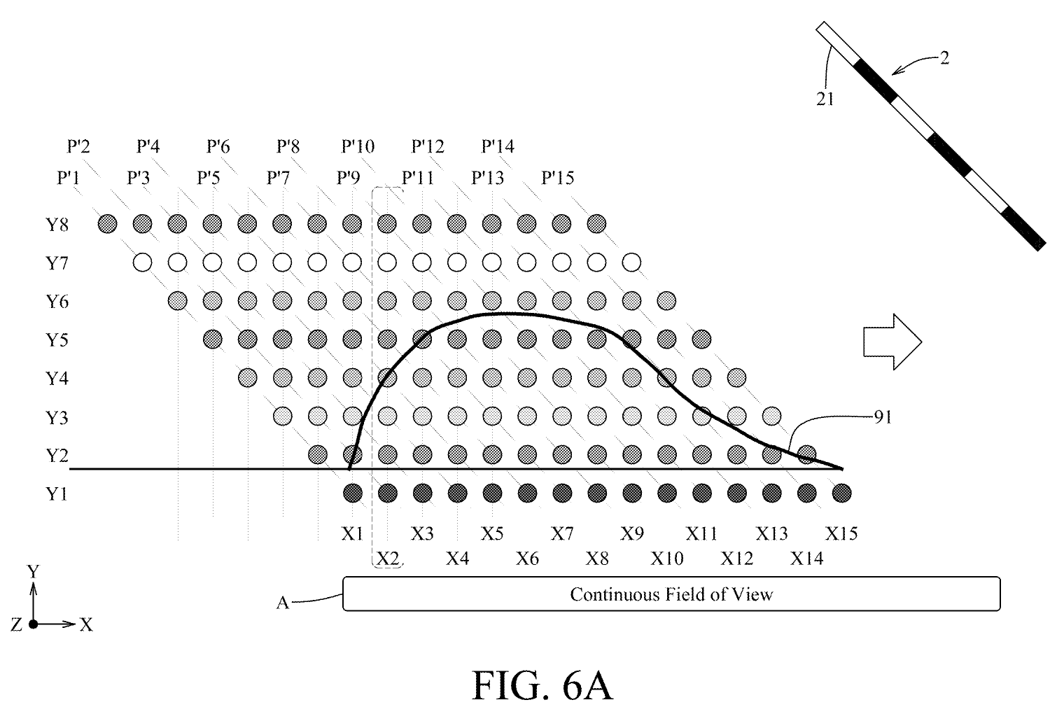

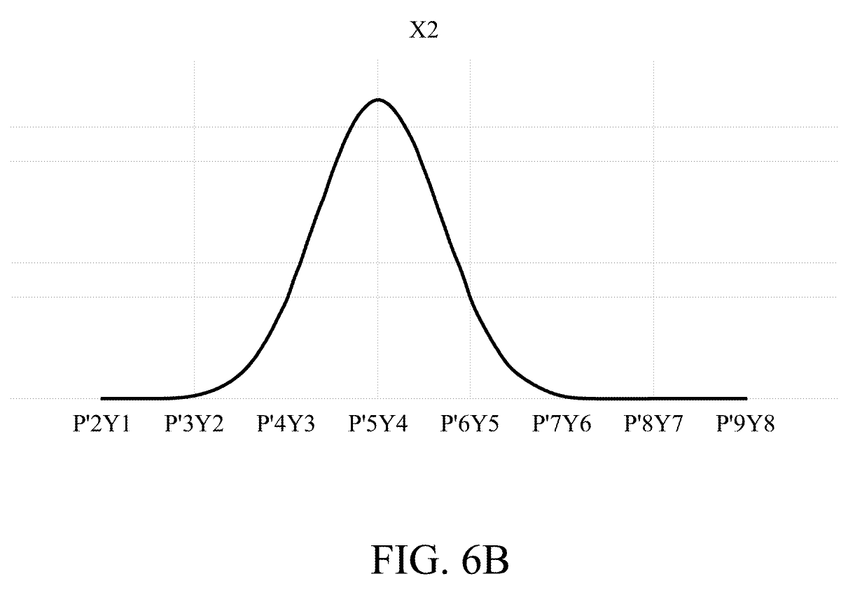

An embodiment of an inspection method implemented by the surface topography inspection system is described hereinafter. Referring to FIG. 6A, the surface topography inspection system scans along the first scanning direction X and projects multiple projected focal plane patterns P’1 to P’15 that are oblique or not parallel to the first scanning direction X. The projected focal plane patterns P'1 to P'15 cover a range from position Y1 to position Y8 along the height direction Y, while the surface topography inspection system moves along the first scanning direction X to capture images continuously. Taking the sine pattern in FIG. 7A as an example, each of the projected focal plane patterns P'1 to P'8 can undergo sinusoidal phase modulation using a phase-shifting method. In some cases where other types of patterns are used by the periodically patterned light beam P, after the surface topography inspection system continuously captures images and the control computation unit 4 reconstructs the captured images by, for example, performing focus measure using the images corresponding to position X2 from the projected focal plane patterns P'2 to P'9, a depth of focus curve, such as that shown in FIG. 6B, can be obtained for height determination. Similarly, a height of the object 9 at position X3 can be inspected from the projected focal plane patterns P'3 to P'10. The same method may be applied to the second scanning direction Z, so details thereof are not repeated herein for the sake of brevity. In this manner, the surface topography inspection system can continuously capture images along the first scanning direction X to continuously extend the range of the field of view A (which may be regarded as a continuous field of view) without performing scanning in the height (Y) direction (i.e., vertical scanning), thereby reducing the number of repeated stop-and-go operations and significantly improving scanning efficiency.

Referring to FIG. 3, in some embodiments, the surface topography inspection system may further include an illuminating device 5 disposed above the bearing surface 300 and electrically connected to the control computation unit 4. The illuminating device 5 may be, for example, an angled light source for automated optical inspection (AOI), and is configured to emit a colored light beam (not shown) toward the bearing surface 300. The colored light beam may be, for example, a red light beam, a green light beam, a blue light beam, or a combination thereof. Furthermore, the colored light beam emitted by the illuminating device 5 is obliquely projected onto the bearing surface 300. The sensor 2 receives the colored light beam reflected by the surface 91 of the object 9 for the control computation unit 4 to perform calculation. When different colored lights are projected onto the same plane, they follow different optical paths upon reflection, so the control computation unit 4 may calculate the surface profile or height variation at that location by capturing the reflected light of a specific color.

In summary, the optical pattern generating surface 11 is set to be oblique to the first scanning direction X, so the resultant projected focal plane pattern P’ is oblique to the first scanning direction X, enabling the projected focal plane pattern P’ to intersect the surface 91 of the object 9 at different horizontal positions of different heights. Accordingly, the surface topography inspection system can obtain height data at various horizontal positions without the need for vertical scanning, by continuously capturing images along the first scanning direction X and performing image reconstruction. As a result, the number of stop-and-go operations of the system is reduced, thereby enhancing inspection efficiency. In addition, the periodically patterned light beam P is projected along the height direction Y that is perpendicular to the first scanning direction X, so that the projected focal plane pattern P’ is perpendicularly projected onto the surface 91 of the object 9 while the projected focal plane pattern P’ is in an inclined orientation relative to the object 9 or the bearing surface 300, thereby avoiding occlusion issues and increasing the imaging depth of field.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A surface topography inspection system adapted to inspect a surface of an object that is placed on a bearing surface, the bearing surface being parallel to a scanning direction in which the surface of the object is to be scanned, said surface topography inspection system comprising:
an optical pattern generator including an optical pattern generating surface that is angled with respect to the scanning direction, and configured to emit a periodically patterned light beam with periodic brightness variations toward the bearing surface;
a sensor including a light-sensing surface; and
a lens assembly disposed to receive the periodically patterned light beam, and configured to permit passage of the periodically patterned light beam, thereby projecting the periodically patterned light beam perpendicularly toward the bearing surface to form a projected focal plane pattern that is oblique to the scanning direction,
wherein said lens assembly is disposed to receive the projected focal plane pattern reflected by the object, and is configured to redirect the projected focal plane pattern thus received to said sensor, thereby forming the projected focal plane pattern on said light-sensing surface.

2. The surface topography inspection system as claimed in claim 1, wherein said optical pattern generating surface and the light-sensing surface are arranged as optically conjugate planes relative to said lens assembly.

3. The surface topography inspection system as claimed in claim 1, further comprising a control computation unit that is electrically coupled to said optical pattern generator and said sensor,
wherein said optical pattern generator and the bearing surface are configured to move relative to each other along the scanning direction,
wherein said control computation unit is configured to control said optical pattern generator to continuously emit the periodically patterned light beam during the relative movement of said optical pattern generator and the bearing surface along the scanning direction, and to control said sensor to, via said lens assembly, continuously form the projected focal plane pattern on said light-sensing surface based on the periodically patterned light beam.

4. The surface topography inspection system as claimed in claim 3, further comprising an illuminating device configured to emit a colored light beam toward the bearing surface, wherein said sensor is configured to receive the colored light beam reflected by the surface of the object.

5. The surface topography inspection system as claimed in claim 4, wherein said illuminating device is an angled lamp, and is configured to emit the colored light beam obliquely toward the bearing surface.

6. The surface topography inspection system as claimed in claim 1, wherein said optical pattern generator is a micro display that is operable to display the periodically patterned light beam of different patterns.

7. The surface topography inspection system as claimed in claim 6, wherein the projected focal plane pattern is one of a sine pattern, a stripe pattern, a circular aperture pattern arranged in an array, an aperture pattern arranged in a honeycomb configuration, and a chessboard pattern.

8. The surface topography inspection system as claimed in claim 1, wherein said lens assembly includes a first lens unit having a first optical axis that intersects said optical pattern generating surface and that is oblique to said optical pattern generating surface, and the periodically patterned light beam emitted by said optical pattern generating surface passes through said lens assembly and is projected by said first lens unit.

9. The surface topography inspection system as claimed in claim 8, wherein said first lens unit is one of an object-side telecentric lens with a long focal length and a bi-telecentric lens.

10. The surface topography inspection system as claimed in claim 8, wherein the first optical axis is perpendicular to the scanning direction, and said lens assembly further includes a beam splitter that is disposed on an extension of the first optical axis at a position to permit passage of the periodically patterned light beam emitted by said optical pattern generating surface, and to reflect the projected focal plane pattern from the object to said light-sensing surface.

11. The surface topography inspection system as claimed in claim 10, wherein said lens assembly further includes a second lens unit disposed between said beam splitter and said light-sensing surface, and having a second optical axis that intersects said beam splitter and said light-sensing surface, and
wherein each of said first lens unit and said second lens unit is one of an object-side telecentric lens with a long focal length and a bi-telecentric lens.

12. The surface topography inspection system as claimed in claim 8, wherein the first optical axis is parallel to the scanning direction, and said lens assembly further includes a beam splitter that is disposed on an extension of the first optical axis at a position to reflect the periodically patterned light beam emitted by said optical pattern generating surface to the bearing surface, and to permit passage of the projected focal plane pattern from the object to said light-sensing surface.

13. The surface topography inspection system as claimed in claim 1, wherein the projected focal plane pattern varies periodically along the scanning direction.

14. The surface topography inspection system as claimed in claim 1, wherein said optical pattern generator includes a grating that has said optical pattern generating surface, and that is configured to permit passage of light to emit the periodically patterned light beam.
